(19) United States
(12) Patent Application Publication
(10) Pub. No.: US 2026/0035856 A1
(43) Pub. Date: Feb. 5, 2026

(54) METHOD AND SYSTEM FOR HANDLING AND TRANSPORTING LAUNDRY IN BAGS

(71) Applicant: INWATEC APS, Odense SV (DK)

(72) Inventor: Mads ANDRESEN, Odense SV (DK)

(73) Assignee: INWATEC APS, Odense SV (DK)

(21) Appl. No.: 19/099,184

(22) PCT Filed: Jul. 26, 2023
(86) PCT No.: PCT/EP2023/070757

§ 371 Date: Jan. 28, 2025

(30) Foreign Application Priority Data
Jul. 29, 2022 (DK) PA202270391

(51) Int. Cl. D06F 93/00; B65G 47/64

(52) U.S. Cl. CPC D06F 93/00; B65G 47/64; B65G 2201/0238; B65G 2201/047

(57) ABSTRACT

A method and system for handling and transporting laundry in bags/sacks by means of laundry handling stations and a transport system for transporting the bags/sacks to, through and/or from and/or between the laundry handling stations. The method includes receiving one or more containers of dirty unsorted laundry at a first laundry handling station, emptying the container(s) of dirty unsorted laundry and putting dirty unsorted laundry into the laundry handling station by removing dirty unsorted laundry from each container, and handling the dirty unsorted laundry in the first laundry handling station and then transporting the laundry from the first laundry handling station to a second laundry handling station.

### TECHNICAL FIELD

The present disclosure relates to a method for handling and transporting laundry in one or more bags/sacks before and/or during/after wash and/or one or more bags/sacks that have been emptied of dirty laundry by means of one or more different and/or one or more of the same types of laundry handling stations and by means of a transport system for transporting the bags/sacks and a system for handling and transporting laundry in one or more bags/sacks before and/or during/after wash and/or one or more bags/sacks that have been emptied of dirty laundry by means of one or more different and/or one or more of the same types of laundry handling stations; and a system for transporting the bags/sacks as defined in the introductory parts of the independent claims.

### BACKGROUND ART

There is known a lot of different types of systems for handling and transporting laundry/cloth in one or more bags before and/or after wash and one or more bags that have been emptied of dirty laundry/cloth by means of cloth or laundry handling stations, e.g., stations for sorting the laundry before washing the sorted laundry in a washing station by means of motorized and automated systems. An example of a process for preparation of laundry items is disclosed in GB 2 293 807 A.

A problem with the solutions of the prior art is that manual filling of dirty laundry from the bags into an automatic sorting station is time consuming and not efficient as a sorting station can only receive a certain amount of dirty laundry at a first end and sort the dirty laundry moving through the station until the sorted laundry reaches a second end of the sorting station to be filled into empty bags as the first end of the sorting station has a limited capacity or volume for receiving the laundry, wherefore the sorting station forms a “bottle neck”/chokepoint for the whole handling system. In some occasions, this may also mean that the worker or operator putting dirty unsorted laundry into the automatic sorting station usually has a higher capacity than the automatic sorting station and has to stop putting in laundry and wait until the sorting station has processed a sufficient amount of laundry before putting in more laundry into the sorting station. There is thus a need for improved capacity of the sorting station but also for the whole automatic system handling dirty laundry for cleaning.

### SUMMARY

It is an object of the present disclosure to mitigate, alleviate or eliminate one or more of the above-identified deficiencies and disadvantages in the prior art and solve at least the above-mentioned problem. According to a first aspect there is provided a method for handling and transporting dirty laundry in one or more bags before wash and one or more bags that have been emptied of dirty laundry by means of one or more different types of laundry handling stations and/or one or more laundry handling stations of the same type and by means of a transport system for transporting the sacks to, through and/or from and/or between the different and/or the same laundry handling stations and for handling clean laundry after wash comprising:—receiving one or more containers of dirty unsorted laundry at a first end of one or more laundry handling stations for filling unsorted dirty laundry into the empty bag/-s being configured to be transported by means of the transport system to and/or from and/or between and/or to be received at/in a first and/or second end of one or more of the laundry handling stations,-emptying the container of dirty unsorted laundry and putting dirty unsorted laundry into the bag/-s by direct filling by hand as one or more manual laundry filling stations and/or emptying the container of dirty unsorted laundry and putting dirty unsorted laundry into the first end of one or more filling station(s) by removing dirty unsorted laundry from each container, and—transporting the bag/-s after manually filling the bag/-s with dirty unsorted laundry and/or transporting the bag/-s when filled with dirty unsorted laundry at the second end of the filling station(s) from the second end of the filling station(s) along the transport system into a second laundry handling station upstream of the filling station(s), the second laundry handling station providing intermediate storage/buffering of the bag/-s filled with dirty unsorted laundry together with dirty sorted laundry transported in other bags by the transport system from one or more third laundry handling stations for sorting the bags with dirty laundry into the same/common intermediate storage/buffering.

This increases the capacity of the handling system as a filling station in itself adds both handling and filling/intermediate storage capacity as a first handling step before the sorting starts, which handling and intermediate storage capacity is further increased by the use of additional buffering arranged between the filling station and the sorting station as a second handling step of the laundry bags/sacks. It will also allow an operator to focus longer on just filling up the buffer of bags, instead of filling up the sorting system intermittently and waiting/jumping between tasks. It also creates a better working flow. Another benefit is that it gives the laundry an overview of the volume of the types of articles they have received and will need to handle. When an operator fills the bag/-s, the operator can assign a category to the bag/-s (on a software interface) as being e.g. towels or sheets or garment, etc., all of which has to be handled differently after the washing process (towels have to be folded differently from sheets, which in turn are folded differently from garments, etc.). So, although the bag/-s in the beginning are containing “unsorted” laundry, they can still be roughly categorized by the operator, and because the bag/-s can be weighed in the filling station (before being lifted to and transported to the storage/buffering station) the laundry establishment will then also know roughly how much they have received of each category of laundry. This allows the laundry establishment to better plan ahead, so they do not wash e.g., 10 bags of towels in a row resulting in a bottleneck later on, while there are no sheets available for the operators handling the sheets. Moreover, the laundry establishment is provided with a better ability of optimizing and avoiding bottlenecks much later in the pipeline/transport system and the whole system by getting an overview early on of what they have received and how much, so they can create a strategy for which exact bags/sacks they should prioritize to have washed first.

According to some embodiments, the method comprises loading the bag/-s directly from a container by hand instead of into the filling station/-s and then transporting the bag/-s when filled manually with dirty unsorted laundry along the transport system via one or more first junctions and one or more second junctions of the transport system into the buffering station upstream of the first and second junctions.

According to some embodiments, the method comprises transporting the bag/-s when filled with dirty unsorted laundry along the transport system via one or more first junctions and one or more second junctions of the transport system upstream of the filling station/-s and into the buffering station upstream of the first and second junctions.

According to some embodiments, the method comprises:—transporting the bag/-s filled with dirty unsorted laundry from the buffering station along the transport system via one or more third junctions of the transport system upstream of the buffering station and further via one or more fourth junctions of the transport system upstream of the third junction;—directing the bag/-s filled with dirty unsorted laundry at/in the fourth junction of the transport system for further transport from the fourth junction to a first end of one or more third laundry handling stations upstream of the fourth junction for sorting the dirty unsorted laundry arriving in the bag/-s;—emptying the content of dirty unsorted laundry in the bag/-s into the first end of the sorting station(s);—transporting the now empty bag/-s from the first end of the sorting station(s) further via one or more fifth junctions of the transport system upstream of the first end of the sorting station(s) into a fourth laundry handling station for the empty bag/-s arriving from the sorting station(s) to be re-used in the filling and sorting stations;-transporting the dirty unsorted laundry from the first end of the sorting station(s) and through the sorting station(s) while sorting the dirty unsorted laundry by means of the sorting station(s) to a second end of the sorting station(s) where the sorting is finished;—filling the dirty and now sorted laundry into the empty bag/-s having been transported by the sorting station(s) to and received at/in the second end of the sorting station(s), and-transporting the bag/-s when filled with dirty sorted laundry from the second end of the sorting station(s) along the transport system to, through and past the first and the second junctions of the transport system upstream of the sorting station(s) to a first end of the buffering station and into the buffering station upstream of the first and second junctions for common intermediate storage of both the sack with dirty unsorted laundry and the bag/-s with dirty sorted laundry in the buffering station.

This increases the capacity of the handling system even further but also the flexibililty of the whole system as it enhances handling, filling and the operational storage capacity before the sorting and/or the washing of the dirty laundry commences as the buffering is arranged between the filling station, i.e. upstream of the filling station, the sorting station and the washing station, i.e. downstream of the sorting and washing stations in the transport flow/path of the sacks with either dirty unsorted laundry or dirty sorted laundry. Advantageously, the operators filling the sacks with dirty unsorted laundry may work more efficient and with a more even workload as the buffering may be done independently of the filling, e.g. more sacks may be filled than sorted and washed at the same time without having to stop the filling work. As an example, the buffering can be made during weekdays and the sorting and/or washing be finished during the weekends.

According to some embodiments, the method comprises:—transporting the bag/-s filled with dirty unsorted laundry and the bag/-s filled with dirty sorted laundry sequentially from a second end of the buffering station along the transport system via the third junction of the transport system and further to the fourth junction of the transport system,—directing the bag/-s filled with dirty unsorted laundry at/in the fourth junction of the transport system for further transport along one transport path of the transport system to the first end of the sorting station(s) for sorting the dirty unsorted laundry and filling dirty sorted laundry into the empty bag/-s forming the bag/-s with dirty sorted laundry being further transported into the buffering station,—directing the bag/-s filled with dirty sorted laundry at/in the fourth junction of the transport system for further transportation along another transport path of the transport system to a first end of a fifth laundry handling station for washing the dirty sorted laundry,—emptying the content of dirty sorted laundry in the bag/-s into the first end of the washing station,—transporting the now empty sacks from the first end of the washing station via the fifth junction or from the second end of the washing station via one or more seventh junction of the transport system upstream of the first end of the washing and the sorting stations into the empty sack handling station for re-use of the empty sacks in the filling and sorting stations, and—transporting the dirty sorted laundry from the first end of the washing station and through the washing station while washing the dirty sorted laundry by means of the washing station to a second end of the washing station where the washing is finished and the sorted and now clean laundry exits.

According to some embodiments, the method comprises:—transporting the empty bag/-s from a second or last end of a last part of the empty sacks handling station(s) to one or more sixth junctions of the transport system upstream of the second or last end of the last part(s) of the empty sack handling station(s) or to one or more sixth and ninth junctions of the transport system upstream of the second or last end of the last part(s) of the empty sack handling station(s),—directing the empty bag/-s at/in the sixth and ninth junction of the transport system, respectively, sequentially either to the second end of the filling station(s) or the second end of the sorting station(s) for receiving and be filled with either the dirty sorted laundry exiting from the sorting station(s) or the dirty unsorted laundry exiting from the filling station(s).

According to some embodiments, the method comprises transporting the emptied container away from the filling station(s).

According to some embodiments, the method comprises directing the bag/-s with dirty unsorted laundry and/or the bag/-s with dirty sorted laundry at/in the second junction of the transport system sequentially before or when entering the buffering station into different transport paths and/or the same transport path of the buffering station.

According to a second aspect there is provided a system for handling and transporting dirty laundry in one or more sacks before wash and one or more sacks that have been emptied of dirty laundry, the system comprising one or more different types of laundry handling stations and/or one or more laundry handling stations of the same type and a transport system for handling and transporting the bag/-s to, through and/or from and/or between the different and/or same laundry handling stations and for handling clean laundry after wash, the system further comprising one or more first laundry handling stations configured to receive, at a first end, dirty unsorted laundry arriving from one or more containers comprising the dirty unsorted laundry, which first laundry handling station(s) is/are configured to fill dirty unsorted laundry into the empty bag/-s by hand and/or to transport the dirty unsorted laundry to a second end of the first laundry handling station where the unsorted dirty laundry is filled into the empty bag/-s that have been transported by means of the transport system to and received at/in the second end of the filling station(s); at least one second laundry handling station arranged upstream of the filling station(s), which second laundry handling station is configured to receive the bag/-s at a first end with dirty unsorted laundry arriving from the filling station(s) to provide intermediate storage as a buffering station for the bag/-s with dirty unsorted laundry together with dirty sorted laundry transported in other bags by the transport system from one or more third laundry handling stations configured to sort the dirty unsorted laundry; at least one third laundry handling station arranged upstream of the buffering station, which third laundry handling station is configured to receive, at a first end, the dirty unsorted laundry transported from a second end of the buffering station and emptied into the first end of the third laundry handling station from the bag/-s and to sort and to, at a second end, fill the empty bag/-s that have been transported by means of the transport system to and received at/in the second end of the sorting station(s) forming one or more sacks with dirty sorted laundry; at least one fourth laundry handling station arranged upstream of the sorting station(s), which fourth laundry handling station is configured to, at a first end, receive the empty bag/-s arriving from the sorting station(s) and to further transport the empty bag/-s from a second or last end of a last part of the empty sacks handling station(s) to filling and sorting stations for re-use in the filling and sorting stations, and at least one fifth laundry handling station arranged upstream of the buffering station, which fifth laundry handling station is configured to receive, at a first end, the bag/-s with dirty sorted laundry arriving from the second end of the buffering station and to move the dirty sorted laundry from the first end of the fifth laundry handling station through the fifth laundry handling station while washing the dirty sorted laundry to a second end of the fifth laundry handling station where the washing is finished and the sorted and now clean laundry exits (taken care of).

According to some embodiments, the transport system comprises at least six junctions configured to direct/route the bag/-s sequentially between the at least five different laundry handling stations: a first junction of the transport system being arranged upstream of the second ends of the filling and sorting stations and downstream of the first end of the buffering station; a second junction of the transport system being arranged upstream of the first transport junction and downstream of the first end of the buffering station; a third junction of the transport system being arranged upstream of the second end of the buffering station and downstream of the sorting and washing stations; a fourth junction of the transport system being arranged upstream of the third junction of the transport system and downstream of the sorting and washing stations; a fifth junction of the transport system being arranged upstream of the first ends of the sorting and washing stations and downstream of the first end of the fourth laundry handling station, and a sixth junction of the transport system being arranged upstream of the second end of the fourth laundry handling station and downstream of the second ends of the sorting and filling stations.

According to some embodiments, the transport system comprises at least three more junctions, a seventh junction of the transport system being arranged upstream of the fourth junction of the transport system and downstream of the washing station; an eight junction of the transport system being arranged upstream of the seventh junction of the transport system and downstream of the last part(s) of the empty sacks handling station(s), and a ninth junction of the transport system being arranged upstream of the sixth junction of the transport system and downstream of the last part(s) of the empty sacks handling station(s).

According to some embodiments, each of the first, the third, and the fifth junctions of the transport system is configured to join at least two different transport paths for the bag/-s downstream of each of these junctions into one and the same transport path for the bag/-s upstream of each of these junctions, and each of the second, the fourth, and the sixth junctions of the transport system is configured to divide/split up one and the same transport path for the bag/-s downstream of each of these junctions into at least two different transport paths for the bag/-s to follow upstream of each of these junctions.

According to some embodiments, each of the first, the third and the fifth junctions and a seventh and a ninth junction of the transport system is configured to join at least two different transport paths for the bag/-s downstream of each of these junctions into one and the same transport path for the bag/-s upstream of each of these junctions, and each of the second, the fourth and the sixth junctions and an eighth junction of the transport system is configured to divide/split up one and the same transport path for the bag/-s downstream of each of these junctions into at least two different transport paths for the bag/-s to follow upstream of each of these junctions.

According to some aspects, the transport system comprises railing/rails and the buffering system comprises both sorted and unsorted dirty laundry articles/items, and that these articles/items can be directed to one or more automatic sorting stations and/or one or more automatic washing stations from the same transport rail system and the same buffering station common for both bags with sorted dirty laundry articles/items and bags with unsorted dirty laundry articles/items. It is the idea that the method and system of the invention keep the dirty laundry “hands-off” after being filled into bags until the dirty laundry has been washed. This is the fundamental invention: the operator/-s load unsorted dirty laundry, such as cloth and/or garments and/or sheets or the like, into bags being handled to have the dirty laundry sorted and washed automatically without any more manual labor.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

Terminology: The term “transport system” is to be interpreted as a system comprising transport paths in the form of railing or conveyors or other similar ways of transporting hanging bags within this field. The term “bag/-s/sack/-s” is/are to be interpreted as one or more semi-flexible or flexible containers configured to receive items of laundry at a top end and through an opening at this top end and to carry items of laundry and being opened at a bottom end to be emptied of the items of laundry when required and closed at the bottom end when required during the handling of the sack/-s/bag/-s and their content of laundry. The terms “up-/downstream” is to be interpreted as directions of movement of laundry and relative positions between laundry handling stations along the transport paths in the form of railing or conveyors or other similar ways of transporting separate pieces and/or piles of articles/items of laundry and/or hanging bags with laundry within this field.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a top view of a system for handling and transporting laundry in one or more bags before and during/after wash and one or more bags that have been emptied of laundry by means of one or more laundry handling stations and a transport system according to an embodiment of the present disclosure.

FIG. 2 shows a perspective view of the systems in FIG. 1 according to an embodiment of the present disclosure.

FIG. 3 shows a top view of a system for handling and transporting laundry in one or more bags before and during/after wash and one or more bags that have been emptied of laundry by means of more laundry handling stations than in the embodiment of FIGS. 1 and 2 and a therefore larger transport system according to another embodiment of the present disclosure.

FIG. 4 shows a top view of a system for handling and transporting laundry in one or more bags before and during/after wash and one or more bags that have been emptied of laundry by means of one or more laundry handling stations and a transport system according to an embodiment of the present disclosure.

FIG. 5 shows a perspective view of the systems in FIG. 4 according to an embodiment of the present disclosure.

### DETAILED DESCRIPTION

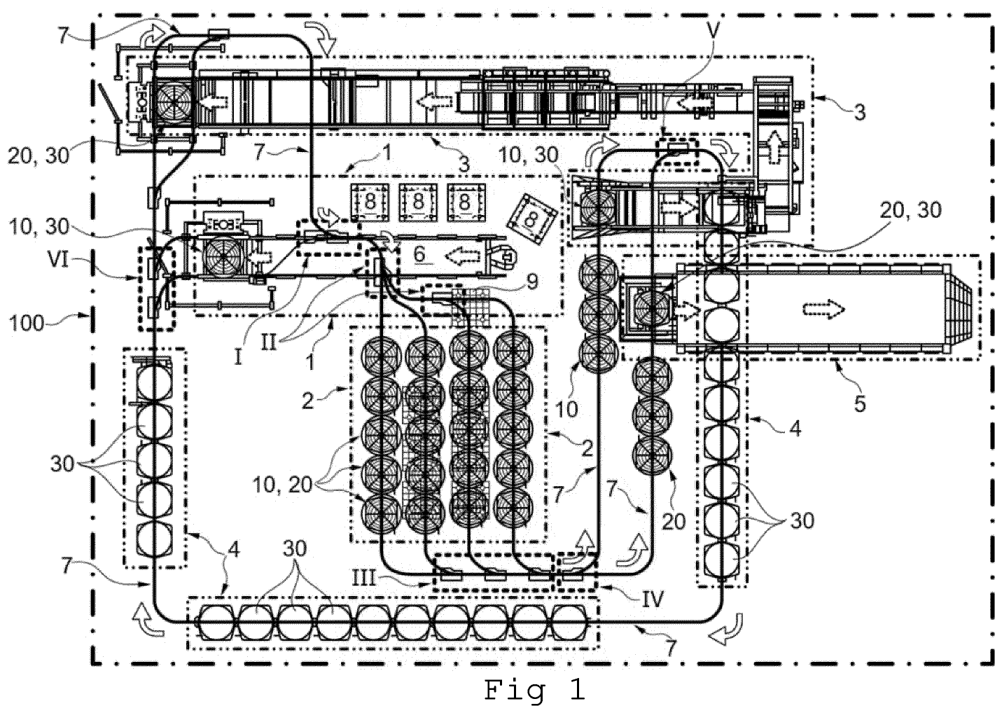

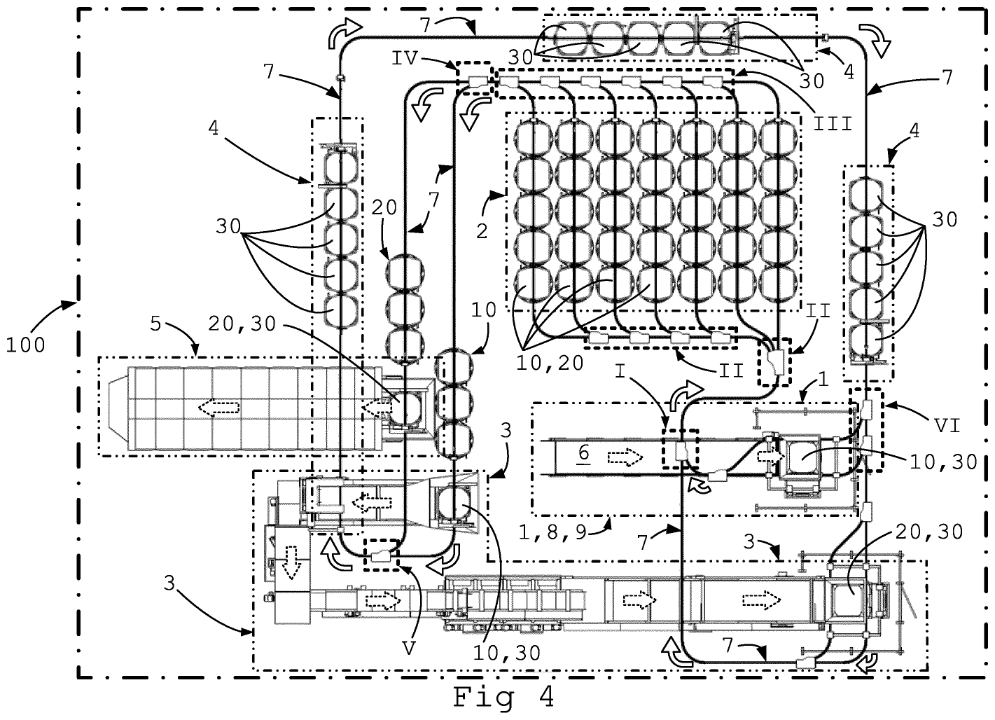

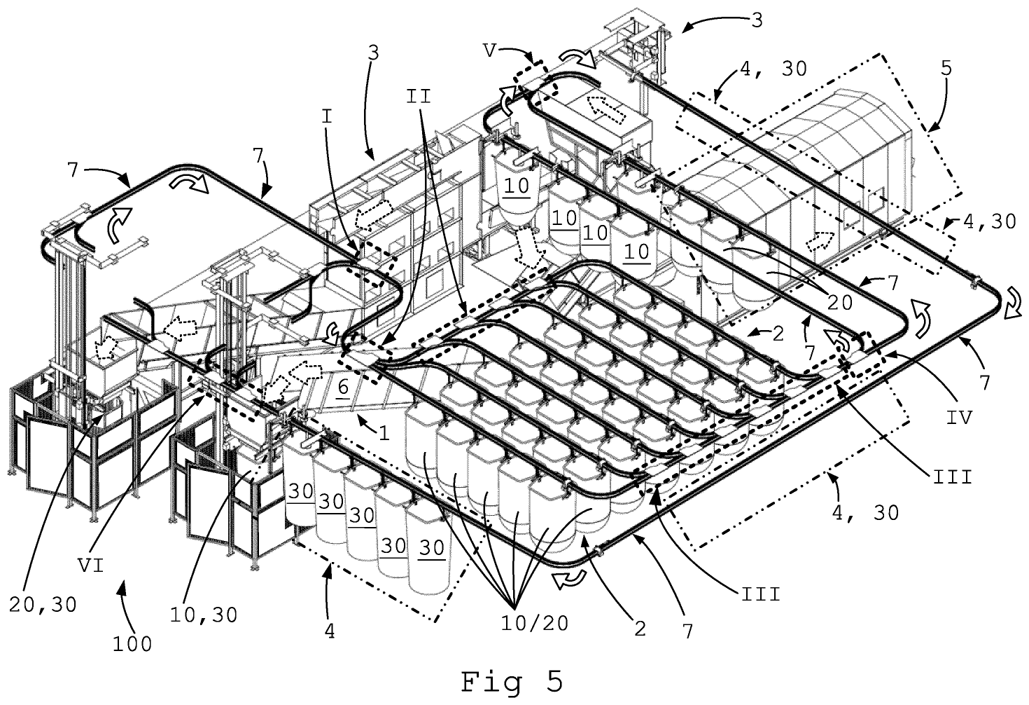

The present disclosure will now be described with reference to the accompanying drawings, in which preferred example embodiments of the disclosure are shown in FIGS. 1 to 5. The disclosure may, however, be embodied in other forms and should not be construed as limited to the herein disclosed embodiments. The disclosed embodiments are provided to fully convey the scope of the disclosure to the skilled person. The straight and curved/bent white arrows in solid and dotted lines in the figures visualize the directions of movement/transport of laundry and/or containers/bags with the laundry before wash and after wash.

The disclosure relates to a method and system 100, 101 for handling and transporting laundry in semi-flexible or flexible containers or bags 10, 20, 30 with a top and a bottom. The bags 10, 20, 30 are openable at the top and bottom. The handling and transport of bags 10, 20, 30 are achieved by means of at least two or more laundry handling stations 1, 1a, 1b, 2, 3, 3a, 3b, 4, 4a, 4b and 5 (see FIGS. 1 to 5) interconnected with each other by being movably/operatively connected to a transport system 7 for transporting the bags 10, 20, 30 to and/or through and/or from and/or between the laundry handling stations. In some embodiments, one or more laundry handling stations 1, 1a, 1b, 3, 3a, 3b, 5 (see FIGS. 1 to 5) use/-s one or more conveyors 6 or conveyor belts 6 to transport laundry and items of laundry from a first end to a second end of each of the laundry handling station/-s 1, 1a, 1b, 3, 3a, 3b, 5. In some embodiments, laundry could be handled partly by hand, i.e. manually, or by one or more machines, e.g. when filled into bags. The laundry is either filled into an empty bag 30 as one or more items of dirty unsorted laundry and then denoted a bag 10 or an empty bag 30 is filled with one or more items of dirty sorted laundry and then denoted a bag 20. The bag(s) 10, 20 having the one or more items of dirty laundry is (are) emptied from the content into associated laundry handling stations 3, 3a, 3b and 5, such as one or more laundry sorting stations 3, 3a, 3b and/or one or more laundry washing stations 5.

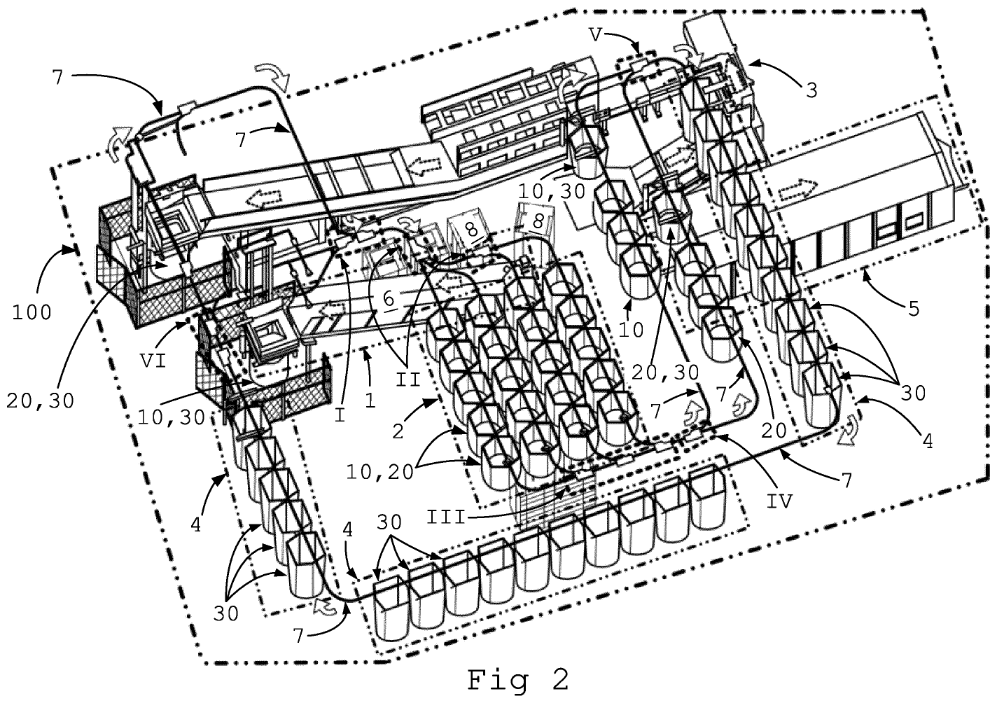

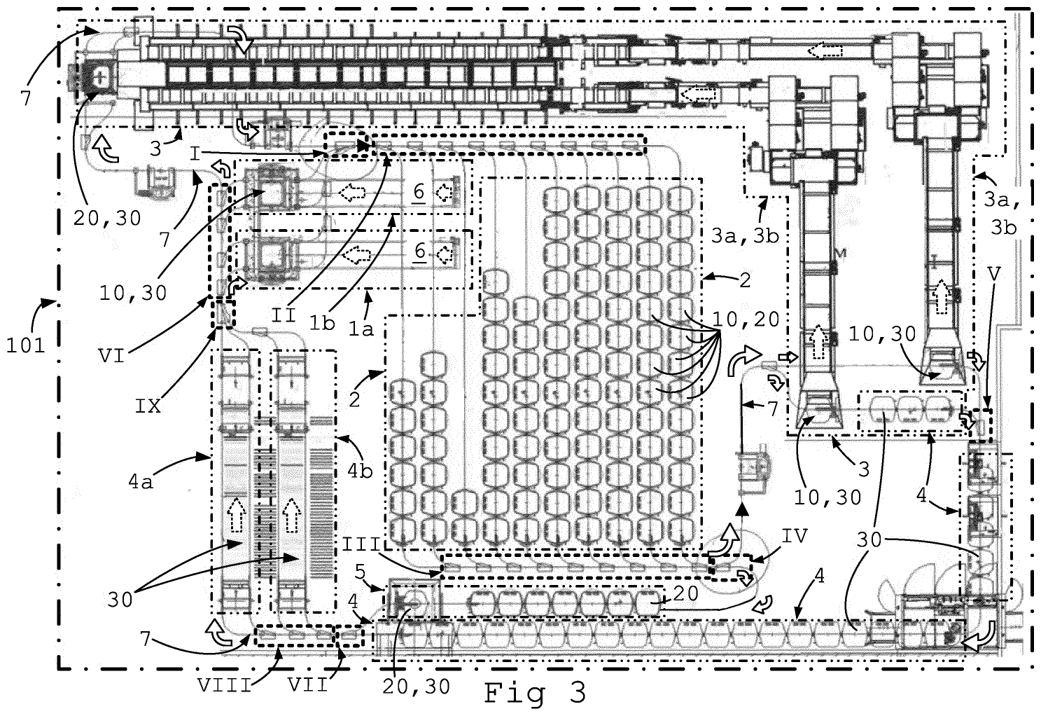

The method comprises receiving one or more containers 8 of one or more items of dirty unsorted laundry at one or more first laundry handling stations 1, 1a, 1b as seen in FIGS. 1 and 2 (this is not shown in FIGS. 3 to 5 but one or more such containers 8 are still used by the system and method in these FIGS. 3 to 5 as otherwise no dirty laundry would be processed in those embodiments). The method comprises emptying the container/-s 8 that in turn comprises one or more items of dirty unsorted laundry and putting the one or more items of dirty unsorted laundry into the first laundry handling station/-s 1, 1a, 1b by removing the item/-s of dirty unsorted laundry from each container. In some embodiments, the container/-s 8 could tip the content of dirty unsorted laundry directly into the first laundry handling station/-s 1, 1a, 1b as an autonomously working tipping or dump cart being transported to and from the laundry station/-s 1, 1a, 1b automatically, i.e. without any manual work involved, and/or the container/-s 8 could be emptied of dirty unsorted laundry by means of robotic arms/cranes or the similar that picks out the dirty unsorted laundry items from the container/-s 8 and then put the dirty laundry into the laundry handling station/-s 1, 1a, 1b automatically. This automated way of emptying dirty laundry from the container/-s 8 by tipping the container/-s and/or by picking dirty laundry directly from the container/-s by use of automated arms or the like could in other embodiments be made in combination with manual emptying of the container/-s 8 to further increase the flexibility of the method and system according to the disclosure. As examples, one or more carts 8 with dirty unsorted laundry could be self-driven and/or remotely controlled for tipping their content of dirty unsorted laundry into the laundry handling stations 1, 1a, 1b and/or one or more robotic cranes or arms could also be remotely operated to perform picking of the dirty laundry from the cart/-s 8 and putting the picked dirty laundry items into the laundry handling stations 1, 1a, 1. In some embodiments, the method comprises emptying the container/-s 8 of dirty unsorted laundry and putting dirty unsorted laundry into the bag/-s 30 by direct filling by hand as one or more manual laundry filling stations and/or emptying the container/-s 8 of dirty unsorted laundry and putting dirty unsorted laundry into one or more first ends of one or more filling station(s) 1, 1a, 1b by removing dirty unsorted laundry from each container 8. In some embodiments, the method comprises handling the item/-s of dirty unsorted laundry in the one or more first laundry handling station/-s 1, 1a, 1b and then transporting the item/-s of dirty unsorted laundry from the one or more first laundry handling station/-s to one or more of the other laundry handling stations 2, 3, 3a, 3b, 4, 4a, 4b and/or 5 sequentially. The method comprises transporting items of dirty unsorted laundry in one or more bags 10 to one or more subsequent second laundry handling stations 2 by means of the transport system 7. The method comprises transporting items of dirty sorted laundry in one or more bags 20 to one or more subsequent second laundry handling stations 2 by means of the transport system 7. The transport system 7 comprises in some embodiments one railing in which the bag/-s 10, 20, 30 hangs and keeps hanging when transported along the railing. The transport system 7 comprises in some embodiments at least two rails in which one or more the bag/-s 10, 20, 30 hangs and keeps hanging in each of the rails when transported along one or both or more rails. The method comprises transporting the bag/-s 10, 20 after manually filling the bag/-s 10 with dirty unsorted laundry and/or transporting the bag/-s 10 when filled with dirty unsorted laundry at the second end of the filling station(s) 1, 1a, 1b from the second end of the filling station(s) along the transport system 7 into a second laundry handling station 2 upstream of the filling station(s) 1, 1a, 1b for intermediate storage/buffering of the bag/-s 10 filled with dirty unsorted laundry together with dirty sorted laundry transported in the other bags 20 by the transport system 7 from one or more third laundry handling stations 3, 3a, 3b for sorting the dirty unsorted laundry into the same/common intermediate storage/buffering 2 as seen in FIGS. 1 to 5.

FIGS. 1, 2, 4 and 5 show a system 100 of a plurality of cloth or laundry handling stations 1, 2, 3, 4, 5 according to an embodiment of the disclosure. FIG. 3 shows another system 101 of a plurality of cloth or laundry handling stations 1a, 1b, 2, 3, 3a, 3b, 4, 4a, 4b, 5, where two or more first laundry handling stations 1a, 1b are utilized for increased filling capacity of laundry in the system 101. In some embodiments of the systems 100, 101 of FIGS. 1, 2, 3, 4 and 5, there could also be two or more first laundry handling stations 1a, 1b and/or two or more third laundry handling stations 3, 3a, 3b utilized for sorting the items of dirty unsorted laundry to provide an increased filling and/or sorting capacity of laundry in the systems 100, 101. In some embodiments of the systems 100, 101 of FIGS. 1 to 5, there could also be two or more fourth laundry handling stations 4, 4a, 4b utilized for handling and transporting empty bags 30 to provide an increased storage and handling capacity of empty bags in the systems 100, 101. The systems 100, 101 comprises in some embodiments (not shown) more than one second laundry handling stations 2 that works as an intermediate and common storage and/or buffering station 2 for bags 10, 20 and in some embodiments, this second buffering station 2 in the system 101 of FIG. 3 is made larger than the one of system 100 in FIGS. 1, 2, 4 and 5, but could in some embodiments be further increased in size, i.e. storage capacity and storage volume in both systems 100, 100, e.g. by adding more railing/rails, i.e. length of railing, in the part of the transport system 7 being arranged in the common buffering station 2.

The first aspect of this disclosure shows a method for handling and transporting dirty laundry in one or more containers/bags 10, 20 before wash and one or more bags 30 that have been emptied of dirty laundry by means of one or more different types of laundry handling stations 1, 1a, 1b, 2, 3, 3a, 3b, 4, 4a, 4b, 5 and/or one or more laundry handling stations 1, 1a, 1b, 2, 3, 3a, 3b, 4, 4a, 4b, 5 of the same type or for the same purpose as seen in FIGS. 1 to 5. The transport system 7 is configured to transport the bags 10, 20, 30 to, through and/or from the different laundry handling stations 1, 1a, 1b, 2, 3, 3a, 3b, 4, 4a, 4b, 5 and for handling clean laundry after wash as shown in FIGS. 1 to 5. The method according to the disclosure comprises receiving one or more containers 8 of dirty unsorted laundry at a first end of one or more first laundry handling stations 1, 1a, 1b. The first laundry handling station/-ss 1, 1a, 1b is configured to fill unsorted dirty laundry into empty bags 30 being transported by means of the transport system 7 to and received at/in a second end of the filling station/-s. The method according to the disclosure comprises emptying the containers 8 of dirty unsorted laundry and putting dirty unsorted laundry into the first end of the first filling stations 1, 1a, 1b by removing the dirty unsorted laundry from each container. The method according to the disclosure comprises transporting the bag/-s 10 when filled with the dirty unsorted laundry at the second end of the filling stations 1, 1a, 1b from the second end of the filling stations along the transport system 7 into one or more second laundry handling station 2 upstream of the filling stations for intermediate storage/buffering of one or more of the bag/-s 10 with dirty unsorted laundry as shown in FIGS. 1 to 5.

The method according to the disclosure comprises transporting the bag/-s 10 when filled with dirty unsorted laundry along the transport system 7 via one or more first junctions I and one or more second junctions Il of the transport system upstream of the filling station/-s 1, 1a, 1b and into the buffering station/-s 2 upstream of the first and second junctions I, Il as shown in FIGS. 1 to 5.

The method according to the disclosure comprises transporting the bag/-s 10 filled with dirty unsorted laundry from the buffering station/-s 2 along the transport system 7 via one or more third junctions III of the transport system upstream of the buffering station/-s 2 and further via one or more fourth junctions IV of the transport system upstream of the third junctions III as shown in FIGS. 1 to 5. The method according to the disclosure comprises directing the bag/-s 10 filled with dirty unsorted laundry at/in the fourth junctions IV of the transport system 7 for further transport from the fourth junctions IV to one or more first ends of one or more third laundry handling station/-s 3, 3a, 3b upstream of the fourth junctions IV for sorting the dirty unsorted laundry arriving in the bag/-s 10 as shown in FIGS. 1 to 5. The method according to the disclosure comprises emptying the content of dirty unsorted laundry in the bag/-s 10 into the first end/-s of the sorting station(s) 3, 3a, 3b as shown in FIGS. 1 to 5. The method according to the disclosure comprises transporting the now empty bags 30 from the first end/-s of the sorting station/-s 3, 3a, 3b further via one or more fifth junctions V of the transport system 7 upstream of the first end/-s of the sorting stations into one or more fourth laundry handling station/-s 4, 4a, 4b for the empty bags 30 arriving from the sorting stations to be re-used in the filling and sorting stations 1, 1a, 1b, 3, 3a, 3b as shown in FIGS. 1 to 5. The method according to the disclosure comprises transporting the dirty unsorted laundry from the first end/-s of the sorting stations 3, 3a, 3b and through the sorting stations while sorting the dirty unsorted laundry by means of the sorting station to one or more second ends of the sorting stations where the sorting is finished as shown in FIGS. 1 to 5. The method according to the disclosure comprises filling the dirty and now sorted laundry into the empty bags 30 having been transported by the sorting stations to and received at/in the second end/-s of the sorting stations 3, 3a, 3b as shown in FIGS. 1 to 5. The method according to the disclosure comprises transporting the bag/-s 20 when filled with dirty sorted laundry from the second end/-s of the sorting stations 3, 3a, 3b along the transport system 7 to, through and past the first and the second junctions I, II of the transport system upstream of the sorting stations 3, 3a, 3b to one or more first ends of the buffering station/-s 2 and into the buffering station/-s upstream of the first and second junctions I, II for common intermediate storage of both the bag/-s 10 with dirty unsorted laundry and the bag/-s 20 with dirty sorted laundry in the buffering station/-s 2 as shown in FIGS. 1 to 5.

The method according to the disclosure comprises transporting the bag/-s 10 filled with dirty unsorted laundry and the bag/-s 20 filled with dirty sorted laundry sequentially from one or more second ends of the buffering station/-s 2 along the transport system 7 via the third junctions III of the transport system and further to the fourth junctions IV of the transport system as shown in FIGS. 1 to 5. The method according to the disclosure comprises directing the bag/-s 10 filled with dirty unsorted laundry at/in the fourth junctions IV of the transport system 7 for further transport along one or more transport paths/rails of the transport system to the first end/-s of the sorting stations 3, 3a, 3b for sorting the dirty unsorted laundry and filling dirty sorted laundry into the empty bag/-s 30 forming the bag/-s 20 being further transported into the buffering station/-s as shown in FIGS. 1 to 5. The method according to the disclosure comprises directing the bag/-s 20 filled with dirty sorted laundry at/in the fourth junctions IV of the transport system 7 for further transportation along one or more other transport paths/rails of the transport system to one or more first ends of one or more fifth laundry handling stations 5 for washing the dirty sorted laundry as shown in FIGS. 1 to 5. The method according to the disclosure comprises emptying the content of dirty sorted laundry in the bag/-s 20 into the first end/-s of the washing station/-s 5 as shown in FIGS. 1 to 5. The method according to the disclosure comprises emptying the content of washed and clean sorted laundry from one or more second end/-s of the washing station/-s 5 as shown in FIGS. 1 to 5. The method according to the disclosure comprises transporting the now emptied bag/-s 30 from the first end/-s of the washing station/-s 5 via the fifth junctions V or transporting the now emptied bag/-s 30 from the second end/-s of the washing station/-s 5 via one or more seventh junctions VII of the transport system 7 upstream of the first end/-s of the washing and the sorting stations 3a, 3b, 5 into the empty bag handling station/-s 4, 4a, 4b for re-use of the empty bags 30 in the filling and sorting stations 1a, 1b, 3, 3a, 3b as shown in FIG. 3. The method according to the disclosure comprises transporting the dirty sorted laundry from the first end/-s of the washing station/-s 5 and through the washing station/-s while washing the dirty sorted laundry by means of the washing station/-s to the second end/-s of the washing station/-s 5 where the washing is finished and the sorted and now clean laundry exits and further handled as shown in FIGS. 1 to 5.

The method according to the disclosure comprises transporting the empty bag/-s 30 from one or more second or last ends of one or more last parts 4, 4a, 4b of the empty bags handling station(s) 4, 4a, 4b to one or more sixth junctions VI of the transport system 7 upstream of the second or last end/-s of the last part/-s 4,4a,4b of the empty bag handling station(s) or to one or more sixth and ninth junctions VI, IX of the transport system 7 upstream of the second or last end/-s of the last part/-s 4a, 4b of the empty bag handling station(s) 4 as shown in FIGS. 1 to 5. The method according to the disclosure comprises directing the empty bag/-s 30 at/in the sixth and ninth junctions VI, IX of the transport system 7, respectively, sequentially either to the second end/-s of the filling stations 1a, 1b or the second end/-s of the sorting stations 3, 3a, 3b for receiving and be filled with either the dirty sorted laundry exiting from the sorting stations or the dirty unsorted laundry exiting from the filling stations as shown in FIG. 3.

The method according to the disclosure comprises transporting each of the emptied containers 9 away from the filling stations 1, 1a, 1b as shown in FIGS. 1 and 2. The method according to the disclosure comprises directing the bag/-s 10 with dirty unsorted laundry and/or the bag/-s 20 with dirty sorted laundry at/in the second junctions Il of the transport system 7 sequentially before or when entering the buffering station/-s 2 into different transport paths/rail/-s and/or the same transport path/-s/rail/-s of the buffering station/-s 2 as shown in FIGS. 1 to 5.

The second aspect of this disclosure shows a system 100, 101 for handling and transporting dirty laundry in one or more bags 10, 20 before wash and/or after wash and one or more empty bags 30 that have been emptied of dirty laundry by means of one or more different and/or same types of laundry handling stations 1, 1a, 1b, 2, 3, 3a, 3b, 4, 4a, 4b, 5 and the transport system 7 for transporting the bags 10, 20, 30 to, through and/or from and/or between the different and/or same laundry handling stations and for handling clean laundry after wash as shown in FIGS. 1 to 5. The system 100, 101 according to the disclosure works according to the method of the disclosure. The system 100, 101 according to the disclosure comprises one or more first laundry handling stations 1, 1a, 1b as shown in FIGS. 1 to 5. The one or more first laundry handling stations 1, 1a, 1b is/are configured to receive, at one or more first ends, dirty unsorted laundry arriving from one or more containers 8 comprising the dirty unsorted laundry as shown in FIGS. 1 and 2. The first laundry handling station/-s 1, 1a, 1b is/are configured to transport the dirty unsorted laundry to one or more second ends of the first laundry handling station/-s where the unsorted dirty laundry is filled into the empty bag/-s 30 that have been transported by means of the transport system 7 to and received at/in the second end/-s of the filling stations 1, 1a, 1b as shown in FIGS. 1 to 5. The system 100, 101 according to the disclosure comprises at least one second laundry handling station 2 arranged upstream of the filling station/-s 1, 1a, 1b as shown in FIGS. 1 to 5. The second laundry handling station/-s 2 is/are configured to receive the bag/-s 10 with dirty unsorted laundry arriving from the filling station/-s 1, 1a, 1b at one or more first ends to provide intermediate storage as one or more buffering stations 2 for the bag/-s 10 with dirty unsorted laundry as shown in FIGS. 1 to 5. The system 100, 101 according to the disclosure comprises at least one third laundry handling station 3, 3a, 3b arranged upstream of the buffering station/-s 2 as shown in FIGS. 1 to 5. The third laundry handling station/-s 3, 3a, 3b is/are configured to receive, at one or more first ends, the dirty unsorted laundry transported from one or more second ends of the buffering station/-s 2 and emptied into the first end/-s of the third laundry handling stations from the bag/-s 10 and to sort and to, at one or more second ends, fill the empty bag/-s 30 that have been transported by means of the transport system 7 to and received at/in the second end/-s of the sorting stations 3, 3a, 3b forming one or more bags 20 with dirty sorted laundry as shown in FIGS. 1 to 5. The system 100, 101 according to the disclosure comprises at least one fourth laundry handling station 4, 4a, 4b arranged upstream of the sorting station/-s 3, 3a, 3b as shown in FIGS. 1 to 5. The fourth laundry handling station/-s 4, 4a, 4b is/are configured to, at one or more first ends, receive the empty bag/-s 30 arriving from the sorting stations 3, 3a, 3b and to further transport the empty bag/-s from one or more second or last ends of one or more last parts 4, 4a, 4b of the empty bags handling station(s) to the filling and sorting stations 1, 1a, 1b, 3, 3a, 3b for re-use therein as shown in FIGS. 1 to 5. The system 100, 101 according to the disclosure comprises at least one fifth laundry handling station 5 arranged upstream of the buffering station/-s 2 as shown in FIGS. 1 to 5. The fifth laundry handling station/-s 5 is/are configured to receive, at one or more first ends, the bag/-s 20 with dirty sorted laundry arriving from the second end/-s of the buffering station/-s 2 and to move the dirty sorted laundry from the first end/-s of the fifth laundry handling station/-s 5 through the fifth laundry handling station/-s while washing the dirty sorted laundry to one or more second end/-s of the fifth laundry handling station/-s where the washing is finished and the sorted and now clean laundry exits as shown in FIGS. 1 to 5.

In the system 100, 101 according to the disclosure, the transport system 7 comprises at least six junctions I-IX configured to direct/route the bag/-s 10, 20, 30 sequentially between the at least five different laundry handling stations 1-5 as shown in FIGS. 1 to 5. The system 100, 101 according to the disclosure comprises one or more first junctions I in the transport system 7 arranged upstream of the second end/-s of the filling and sorting stations 1, 1a, 1b, 3, 3a, 3b and downstream of the first end/-s of the buffering station/-2 as shown in FIGS. 1 to 5. The system 100, 101 according to the disclosure comprises one or more second junctions Il in the transport system 7 arranged upstream of the first transport junction/-s I and downstream of the first end/-s of the buffering station/-s 2 as shown in FIGS. 1 to 5. The system 100, 101 according to the disclosure comprises one or more third junctions Ill in the transport system 7 arranged upstream of the second end/-s of the buffering station/-s 2 and down-stream of the sorting and washing stations 3, 3a, 3b, 5 as shown in FIGS. 1 to 5. The system 100, 101 according to the disclosure comprises one or more fourth junctions IV in the transport system 7 arranged upstream of the third junction/-s Ill of the transport system and downstream of the sorting and washing stations 3, 3a, 3b, 5 as shown in FIGS. 1 to 5. The system 100, 101 according to the disclosure comprises one or more fifth junctions V in the transport system 7 arranged upstream of the first end/-s of the sorting and washing stations 3, 3a, 3b, 5 and downstream of the first end/-s of the fourth laundry handling station/-s 4, 4a, 4b as shown in FIGS. 1 to 5. The system 100, 101 according to the disclosure comprises one or more sixth junctions VI in the transport system 7 arranged upstream of the second end/-s of the fourth laundry handling station/-s 4,4a,4b and downstream of the second end/-s of the sorting and filling stations 1, 1a, 1b, 3, 3a, 3b as shown in FIGS. 1 to 5.

In the system 101 or 100 according to the disclosure, the transport system 7 comprises at least three more junctions VII-IX as shown in FIG. 3. The system 100, 101 according to the disclosure comprises one or more seventh junctions VII in the transport system 7 arranged upstream of the fourth junction/-s IV of the transport system and downstream of the washing station/-s 5 as shown in FIG. 3. The system 100, 101 according to the disclosure comprises one or more eighth junctions VIII in the transport system 7 arranged upstream of the seventh junction/-s VII of the transport system and downstream of the last part/-s 4a, 4b of the empty bags handling station/-s 4 as shown in FIG. 3. The system 100, 101 according to the disclosure comprises one or more ninth junctions IX in the transport system 7 arranged upstream of the sixth junction/-s VI of the transport system and downstream of the last part/-s 4a, 4b of the empty bags handling station/-s 4 as shown in FIG. 3.

In the system 100, 101 according to the disclosure, each of the first I, the third III and the fifth V junctions of the transport system 7 is configured to join at least two different transport paths/rails for the bag/-s 10, 20 downstream of each of these junctions into one and the same transport path for the bag/-s upstream of each of these junctions as shown in FIGS. 1 to 5. In the system 100, 101 according to the disclosure, each of the second II, the fourth IV and the sixth VI junctions of the transport system 7 is configured to divide or split up one and the same transport path/railing for the bag/-s 10, 20 down-stream of each of these junctions into at least two different transport paths/rails for the bag/-s up-stream of each of these junctions as shown in FIGS. 1 to 5.

In the system 100, 101 according to the disclosure, each of the first I, the third III and the fifth V junctions and one or more seventh VII and one or more ninth IX junctions of the transport system 7 is configured to join at least two different transport paths/rails for the bag/-s 10, 20 downstream of each of these junctions into one and the same transport path/rails for the bag/-s upstream of each of these junctions as shown in FIG. 3. In the system 100, 101 according to the disclosure, each of the second II, the fourth IV and the sixth VI junctions and one or more eighth VIII junctions of the transport system 7 is configured to divide/split up one and the same transport path/railing for the bag/-s 10, 20 downstream of each of these junctions into at least two different transport paths/rails for the bag/-s upstream of each of these junctions as shown in FIG. 3.

The system 100, 101 comprises in some embodiments one or more different types of laundry handling stations 1, 1a, 1b, 2, 3, 3a, 3b, 4, 4a, 4b, 5 as shown in FIGS. 1 to 5. In some embodiments, the transport system 7 comprises one and the same railing and/or a combination of one or more different types of railings and/or one or more of the same type of railing for transporting bags 10, 20, 30 to, through and/or from and/or between laundry handling stations 1, 1a, 1b, 2, 3, 3a, 3b, 4, 4a, 4b, 5 (see FIGS. 1 to 5). The system 100, 101 comprises in some embodiments a combination of one or more different types of laundry handling stations 1, 1a, 1b, 2, 3, 3a, 3b, 4, 4a, 4b, 5 and one or more laundry handling stations of the same type and a transport system 7 for transporting the bags 10, 20, 30 to, through and/or from and/or between the laundry handling stations (see FIGS. 1 to 5).

The functionality provided by the method and the system(s) 100, 101 enable transporting unsorted and sorted dirty laundry before being washed and clean sorted laundry after wash between, to and from one or more or all of the laundry handling stations 1, 1a, 1b, 3, 3a, 3b, 4, 4a, 4b, 5 by usage of one or more devices and/or machines, power sources, electric motors etc. operatively controlled by one or more control units, this being known by the skilled person. One step provided by the method and the system(s) 100, 101 concerns one or more or all sorting stations 3, 3a, 3b, where individual articles/items of unsorted batch/-es of dirty laundry received at/in the first end(s) of sorting station(s) 3, 3a, 3b are first separated into smaller piles of one or more pieces by one or more machines or robots controlled by one or more control units. This step comprises examining the smaller piles of one or more dirty laundry articles by one or more sensors (e.g. RFID scanners, cameras, etc.). After this, the dirty laundry articles are transported by one or more conveyors of sorting station(s) 3, 3a, 3b to be temporarily stored in one or more containers of the sorting station(s) based on criteria in information gathered by said sensors. Once a certain amount of dirty laundry articles has been sorted in any one storage container of the sorting station(s) 3, 3a, 3b, that container will off-load the batch of now sorted dirty laundry articles onto one or more other conveyors of the sorting station(s). Then, the other conveyor(s) of sorting station(s) 3, 3a, 3b transport/-s the now sorted dirty laundry articles to the second end(s) of the sorting station(s). There, the now sorted dirty laundry articles are loaded into the empty bag(s) 30. The bag(s) now filled with dirty sorted laundry is (are) then transported as the bag(s) 20 with dirty sorted laundry to the buffering station(s) 2 as the common intermediate storage of both bags 10 with dirty unsorted laundry and/or bags 20 with dirty sorted laundry. In some aspects, the buffering station(s) 2 will only comprise bags 10 with dirty unsorted laundry or will only comprise bags 20 with dirty sorted laundry or will comprise both bags 10 with dirty unsorted laundry and bags 20 with dirty sorted laundry in varying amounts/numbers depending on how many dirty laundry bags of each category, i.e. with sorted laundry or unsorted laundry being processed in the present system(s) 100, 101 and by the method during a certain period of time, e.g. weekdays or weekends. Handling of dirty laundry bags in any of the other types of laundry handling stations 1, 1a, 1b, 4, 4a, 4b, 5, i.e. the filling station(s) 1, 1a, 1b; the buffering station(s) 2 storing bags 10, 20 of laundry/cloth not being washed yet, i.e. bags 10 with not yet sorted dirty laundry/cloth and/or bags 20 with sorted dirty laundry/cloth; the station(s)/storage(s) 4, 4a, 4b of empty bags 30; the station(s) 5 for automatic wash of sorted dirty laundry/cloth arriving in bags 20, and the transport system 7 is done in a corresponding way as for the sorting station(s) 3, 3a, 3b by use of similar and/or corresponding equipment, such as one or more machines or robots, power sources, electric motors, pathways (such as railing and/or conveyors if not filling the bags 10 directly by hand) and by one or more sensors (e.g. RFID scanners, cameras, etc.) operatively controlled by one or more control units providing a more autonomous functionality compared to prior art.

### REFERENCE NUMBERS

1, 1a, 1b. Station for filling of unsorted dirty laundry/cloth into bags 10.
2. Station for intermediate storage/buffering of bags of laundry/cloth not being washed yet comprising bags 10 with not yet sorted laundry/cloth received from filling station(s) 1, 1a, 1b and/or bags 20 with sorted laundry/cloth received from sorting station(s) 3, 3a, 3b.
3, 3a, 3b. Station/System/Machine for automatically sorting unsorted dirty laundry/cloth arriving in bags 10 from buffering station(s) 2, each bag being emptied into station(s) 3, 3a, 3b.
4, 4a, 4b. Station(s)/Storage(s) for empty bags 30 arriving from sorting 3, 3a, 3b and/or washing station(s) 5 to be delivered to filling s 1, 1a, 1b and sorting stations 3, 3a, 3b for re-use therein.
5. Station(s) for automatically washing sorted dirty laundry/cloth arriving in bags 20 from the buffering station(s) 2, each bag being emptied into this/these station(s) 5.
6. Transport member/Conveyer belt(s).
7. Transport/Rail system for transport of bags hanging in transport path(s)/railing.
8. Container(s)/Trolley(s)/Cart(s) with unsorted dirty laundry/cloth.
9. Container(s)/Trolley(s)/Cart(s) having no unsorted dirty laundry/cloth, i.e. empty container(s)/trolley(s) coming from filling station(s) 1, 1a, 1b after being emptied.
10. Bag/-s with or being ready/prepared to receive/be filled with unsorted dirty laundry/cloth.
20. Bag/-s with or being ready/prepared to receive/be filled with sorted dirty laundry/cloth.
30. Bag/-s with no laundry/cloth, i.e., empty bag/-s arriving from sorting and/or washing station(s) 3, 3a, 3b, 5 after being emptied.
100. One system for handling both unsorted and sorted dirty laundry/cloth before wash and sorted clean laundry/cloth after wash.
101. Another system for handling both unsorted and sorted dirty laundry/cloth before wash and sorted clean laundry/cloth after wash.
I. Junction(s) of transport system 7 where bags 10 with unsorted dirty laundry and bags 20 with sorted dirty laundry join/are directed/routed into the same transport path.
II. Junction(s) of system 7 where bags 10 with unsorted dirty laundry and/or bags 20 with sorted dirty laundry are received when arriving to the buffer station(s) 2 and where the bag/-s, before/when entering the buffer station(s), may be routed/re-routed into different transport paths and/or the same transport path at/in the buffer station(s).
III. Junction(s) of system 7 where bags 10 with unsorted dirty laundry and/or bags 20 with sorted dirty laundry leaving/exiting the buffer station(s) 2 are re-routed into the same transport path of the system 7.
IV. Junction(s) of system 7 where bags 10 with unsorted dirty laundry that have exited the buffer station(s) 2 are re-routed into one transport path to continue to the sorting station(s) 3, 3a, 3b and bags 20 with sorted dirty laundry that have exited the buffer station(s) 2 are re-routed into another transport path to continue to the washing station(s) 5.
V. Junction(s) of system 7 where bags 10, 20 emptied of laundry into the sorting and/or washing station(s) 3, 3a, 3b, 5 are re-routed into one and the same transport path as empty bags 30 to continue to the empty bag handling station(s) 4, 4a, 4b for reuse.
VI. Junction(s) of system 7 where empty bags 30 are re-routed into either one transport path leading to the filling station(s) 1, 1a, 1b for receiving unsorted dirty laundry or another transport path leading to the sorting station(s) 3, 3a, 3b for receiving sorted dirty laundry.
VII. Junction(s) of system 7 where empty bags 30 exiting the washing station(s) 5 are re-routed into the same transport path as the empty bag handling station(s) 4, 4a, 4b for reuse.
VIII. Junction(s) of system 7 where empty bags 30 arriving from washing station(s) 5 and from further downstream of the empty bag handling station(s) 4, 4a, 4b are routed/re-routed into different transport paths and/or the same transport path at/in a first end of last part(s) 4a, 4b of the empty bag handling station(s) 4 before being lead to filling station(s) 1, 1a, 1b to receive unsorted dirty laundry or to the second ends of sorting station(s) 3, 3a, 3b to receive sorted dirty laundry.
IX. Junction(s) of system 7 where empty bags 30 exiting a second end of last part(s) 4a, 4b of the empty bag handling station(s) 4 further downstream for reuse are re-routed into the same transport path at/in before being re-routed either to the filling station(s) 1, 1a, 1b for receiving unsorted dirty laundry or to the second ends of the sorting station(s) 3, 3a, 3b for receiving sorted dirty laundry.

1. A method for handling and transporting dirty laundry in one or more bags before wash and one or more bags that have been emptied of dirty laundry by one or more laundry handling stations and by a transport system for transporting the one or more bags before wash and the one or more bags that have been emptied of dirty laundry with respect to, through and/or from and/or between the laundry handling stations and for handling clean laundry after wash, the method comprising:
receiving a container of dirty unsorted laundry at a first end of a first laundry handling and filling station for filling the dirty unsorted laundry into a first bag that is empty, wherein the bag that is empty is configured to be transported by a transport system to be received at the first laundry handling and filling station;
emptying the container of dirty unsorted laundry and putting the dirty unsorted laundry into the first bag that is empty by direct filling by hand at the first laundry handling and filling station or emptying the container of dirty unsorted laundry and putting the dirty unsorted laundry into the first end of the first laundry handling and filling station by removing dirty unsorted laundry from the container; and
transporting the first bag after manually filling the first bag with the dirty unsorted laundry or transporting the first bag when filled with the dirty unsorted laundry at a second end of the first laundry handling and filling station from the second end of the first laundry handling and filling station along the transport system into a second laundry handling and buffering station downstream of the first laundry handling and filling station, the second laundry handling and buffering station providing intermediate storage/buffering of both the first bag filled with the dirty unsorted laundry and a second bag containing dirty sorted laundry that was transported by the transport system from a third laundry handling and sorting station to the second laundry handling and buffering station.

2. The method according to claim 1 comprising:
transporting the first bag when filled with the dirty unsorted laundry along the transport system via a first junction and a second junction of the transport system downstream of the first laundry handling and filling station and into the second laundry handling and buffering station downstream of the first junction and the second junction.

3. The method according to claim 2 comprising:
transporting the first bag filled with the dirty unsorted laundry from the second laundry handling and buffering station along the transport system via a third junction of the transport system downstream of the second laundry handling and buffering station and further via a fourth junction of the transport system downstream of the third junction;
directing the first bag filled with the dirty unsorted laundry at the fourth junction of the transport system for further transport from the fourth junction to a first end of a third laundry handling and sorting station downstream of the fourth junction for sorting the dirty unsorted laundry arriving in the first bag;
emptying the dirty unsorted laundry in the first bag into the first end of the third laundry handling and sorting station so that the first bag is empty again;
transporting the first bag that is empty again from the first end of the third laundry handling and sorting station and further via a fifth junction of the transport system downstream of the first end of the third laundry handling and sorting station into a fourth laundry handling station for the first bag that is empty again and is arriving from the third laundry handling and sorting station to be re-used in the first laundry handling and filling station and the third laundry handling and sorting station;
transporting the dirty unsorted laundry emptied from the first bag from the first end of the third laundry handling and sorting station and through the third laundry handling and sorting station while sorting the dirty unsorted laundry emptied from the first bag by the third laundry handling and sorting station to a second end of the third laundry handling and sorting station where the sorting is finished to provide dirty sorted laundry;
filling the dirty sorted laundry into the second bag that has been emptied and transported to the second end of the third laundry handling and sorting station; and
transporting the second bag when filled with the dirty sorted laundry from the second end of the third laundry handling and sorting station along the transport system to, through and past the first junction and the second junction of the transport system downstream of the third laundry handling and sorting station to a first end of the second laundry handling and buffering station and into the second laundry handling and buffering station downstream of the first junction and the second junction for common intermediate storage of both the first bag with dirty unsorted-laundry and the second bag with dirty sorted laundry in the second laundering and buffering station.

4. The method according to claim 3 comprising:
transporting the first bag with dirty unsorted laundry and the second bag filled with dirty sorted laundry sequentially from a second end of the second laundry handling and buffering station along the transport system via the third junction of the transport system and further to the fourth junction of the transport system;
directing the first bag filled with dirty unsorted laundry at the fourth junction of the transport system for further transport along one transport path of the transport system to the first end of the third laundry handling and sorting station for sorting the dirty unsorted laundry of the first bag and filling the dirty sorted laundry delivered to the third laundry handling and sorting station into a third bag that is empty and transporting the third bag with the dirty sorted laundry into the second laundry handling and buffering station;
directing the second bag filled with dirty sorted laundry at the fourth junction of the transport system for further transportation along another transport path of the transport system to a first end of a fifth laundry handling and washing station for washing the dirty sorted laundry;
emptying the dirty and sorted laundry of the second bag at the fifth laundry handling and washing station into the first end of the fifth laundry handling and washing station;
transporting the first bag that has been emptied at the fifth laundry handling and washing station from the first end of the fifth laundry handling and washing station via the fifth junction or from a second end of the fifth laundry handling and washing station via a sixth junction of the transport system downstream of the first end of the fifth laundry handling and washing station and the first end of the third laundry handling and sorting station into the fourth laundry handling station for re-use of the first bag in the first laundry handling and filling station and the third laundry handling and sorting station;
transporting the dirty and sorted laundry emptied from the first bag from the first end of the fifth laundry handling and washing station and through the fifth laundry handling and washing station while washing the dirty sorted laundry by the fifth laundry handling and washing station to a second end of the fifth laundry handling and washing station where the washing is finished and the sorted and now clean laundry exits.

5. The method according to claim 4 comprising:
transporting the first bag that has been emptied at the fifth laundry handling and washing station from the fourth laundry handling station to a seventh junction of the transport system downstream of the fourth laundry handling station or to an eighth junction of the transport system downstream of the second or last end of the fourth laundry handling station; and
directing the first bag at the seventh junction or the eighth junction of the transport system, respectively, either to the second end of the first laundry handling and filling station or the second end of the third laundry handling and sorting station for receiving and be filled with either the dirty sorted laundry exiting from the third laundry handling and sorting station or the dirty unsorted laundry exiting from first laundry handling and filling station.

6. The method according to claim 1 comprising:
after the container fills the first empty bag with the dirty unsorted laundry, transporting the container away from the first laundry handling and filling station.

7. The method according to claim 2 comprising:
directing the first bag with dirty unsorted laundry and the second bag with dirty sorted laundry at the second junction of the transport system sequentially before or when entering the second laundry handling and buffering station into different transport paths and/or the same transport path of the second laundry handling and buffering station.

8. A system for handling and transporting dirty laundry in one or more bags before wash and one or more bags that have been emptied of dirty laundry, the system comprising:
a transport system for handling and transporting a first bag and a second bag;
a first laundry handling and filling station configured to receive, at a first end, dirty unsorted laundry arriving from a container of dirty unsorted laundry, which first laundry handling station is configured to either fill the dirty unsorted laundry of the container into the first bag, which is empty, by hand or to transport the dirty unsorted laundry to a second end of the first laundry handling and filling station where the unsorted dirty laundry is filled into the first bag, which is empty, that has been transported by the transport system to the second end of the first laundry handling and filling station;
a second laundry handling and buffering station arranged downstream of the first laundry handling and filling station which second laundry handling and buffering station is configured to receive the first bag at a first end with dirty unsorted laundry arriving from the first laundry handling and filling station to provide intermediate storage for the first bag with dirty unsorted laundry together with a second bag containing dirty sorted laundry that was transported by the transport system from a third laundry handling and sorting station configured to sort the dirty unsorted laundry;
the third laundry handling and sorting station arranged downstream of the second laundry handling and buffering station, which third laundry handling and sorting station is configured to receive, at a first end, the dirty unsorted laundry transported from a second end of the second laundry handling and buffering station and emptied into the first end of the third laundry handling and sorting station from the first bag and to sort and to, at a second end, fill the first bag, which is empty, that has been transported by the transport system to and received at the second end of the third laundry handling and sorting station forming the second bag to be filled with dirty sorted laundry;
a one fourth laundry handling station arranged downstream of the third laundry handling and sorting station, which fourth laundry handling station is configured to, at a first end, receive a third bag that is empty arriving from the third laundry handling and sorting station and to further transport the third bag that is empty from the fourth laundry handling station to the first laundry handling and filling station and the third laundry handling and sorting station for re-use in the first laundry handling and filling station and the third laundry handling and sorting station; and
a one fifth laundry handling and washing station arranged downstream of the second laundry handling and buffering station, which fifth laundry handling and washing station is configured to receive, at a first end, the second bag with dirty sorted laundry arriving from the second end of the second laundry handling and buffering station and to move the dirty sorted laundry from the first end of the fifth laundry handling and washing station through the fifth laundry handling and washing station while washing the dirty sorted laundry to a second end of the fifth laundry handling and washing station where the washing is finished and the sorted and now clean laundry exits.

9. The system according to claim 8, wherein the transport system comprises a first junction, a second junction, a third junction, a fourth junction, a fifth junction, and a sixth junction configured to direct/route the first bag, the second bag, and the third bag sequentially between the first laundry handling and filling station, the second laundry handling and buffering station, the third laundry handling and sorting station, the fourth laundry handling station, and the fifth laundry handling and washing station;
wherein a first junction of the transport system being arranged downstream of the second end of the first laundry handling and filling station and the second end of the third laundry handling and sorting station and downstream of the first end of the second laundry handling and-buffering station;
wherein a second junction of the transport system being arranged downstream of the first junction and downstream of the first end of the second laundry handling and buffering station;
wherein a third junction of the transport system being arranged downstream of the second end of the second laundry handling and buffering station and downstream of the third laundry handling and sorting station and the fifth laundry handling and washing station;
wherein a fourth junction of the transport system being arranged downstream of the third junction of the transport system and downstream of the third laundry handling and sorting station and the fifth laundry handling and washing station;
wherein a fifth junction of the transport system being arranged downstream of the first end of the third laundry handling and sorting station and the first end of the fifth laundry handling and washing station and upstream of the first end of the fourth laundry handling station; and
a sixth junction of the transport system being arranged downstream of the second end of the fourth laundry handling station and downstream of the second end of the first laundry handling and filling station and the second end of the third laundry handling and sorting station.

10. The system according to claim 9, wherein the transport system comprises:
a seventh junction of the transport system being arranged downstream of the fourth junction of the transport system and downstream of the fifth laundry handling and washing station;
an eighth junction of the transport system being arranged downstream of the seventh junction of the transport system and downstream of the fourth laundry handling station; and
a ninth junction of the transport system being arranged upstream of the sixth junction of the transport system and downstream of the fourth laundry handling station.

11. The system according to claim 9, wherein each of the first junction, the third junction, and the fifth junction of the transport system is configured to join at least two different transport paths for the first bag and the second bag downstream of each of the first junction, the third junction, and the fifth junction into one and the same transport path for the first bag and the second bag downstream of each of the first junction, the third junction, and the fifth junction, and each of the second junction, the fourth junction, and the sixth junction of the transport system is configured to divide/split up one and the same transport path for the first bag and the second bag upstream of each of the first junction, the third junction, and the fifth junction into at least two different transport paths for the first bag and the second bag to follow downstream of each of the first junction, the third junction, and the fifth junction.

12. The according to claim 9, wherein each of the first junction, the third junction and the fifth junction and a seventh junction and an eighth junction of the transport system is configured to join at least two different transport paths for the first bag and the second bag upstream of each of the first junction, the third junction, the fifth junction, the seventh junction, and the eighth junction into one and the same transport path for the first bag and the second bag downstream of each of the first junction, the third junction, the fifth junction, the seventh junction, and the eighth junction, and each of the second junction, the fourth junction and the sixth junction and a ninth junction of the transport system is configured to divide/split up one and the same transport path for the first bag and the second bag upstream of each of the second junction, the fourth junction and the sixth junction and the ninth junction into at least two different transport paths for the first bag and the second bag to follow upstream of each of the second junction, the fourth junction and the sixth junction-and the ninth junction.

13. The method according to claim 6 comprising:
before or when entering the second laundry handling and buffering station, directing the first bag with dirty and unsorted laundry and the second bag with dirty and sorted laundry at the second laundry handling and buffering station to a junction of the transport system sequentially so that the first bag and the second bag travel different transport paths or the same transport path of the second laundry handling and buffering station.

14. The system according to claim 11, wherein each of the first junction, the third junction, and the fifth junction and a seventh junction and an eighth junction of the transport system is configured to join at least two different transport paths for the first bag and the second bag upstream of each of the first junction, the third junction, the fifth junction, the seventh junction, and the eighth junction into one and the same transport path for the first bag and the second bag downstream of each of the first junction, the third junction, the fifth junction, the seventh junction, and the eighth junction, and each of the second junction, the fourth junction, and the sixth junction and a ninth junction of the transport system is configured to divide/split up one and the same transport path for the first bag and the second bag upstream of each of the second junction, the fourth junction, the sixth junction, and the ninth junction into at least two different transport paths for the first bag and the second bag to follow downstream of each of the second junction, the fourth junction, the sixth junction and the ninth junction.
